(19) United States
(12) Patent Application Publication
(10) Pub. No.: US 2020/0209172 A1
(43) Pub. Date: Jul. 2, 2020

(54) X-RAY INSPECTION DEVICE FOR DRONE, X-RAY INSPECTION DEVICE EMPLOYING DRONE, AND X-RAY GENERATOR DEVICE FOR DRONE

(71) Applicant: TSUKUBA TECHNOLOGY CO., LTD., Tsukuba-shi (JP)

(72) Inventors: Bo Wang, Tsukuba-shi (JP); Norio Saito, Tsukuba-shi (JP); Shuichi Suzuki, Tsukuba-shi (JP); Xiaojun Liu, Tsukuba-shi (JP); Wenkang Guo, Tsukuba-shi (JP)

(73) Assignee: TSUKUBA TECHNOLOGY CO., LTD., Tsukuba-shi (JP)

(21) Appl. No.: 16/725,351

(22) Filed: Dec. 23, 2019

Related U.S. Application Data
(63) Continuation of application No. PCT/JP2018/014028, filed on Mar. 31, 2018.

(51) Int. Cl. G01N 23/083; G05D 1/00; G01N 23/04

(52) U.S. Cl. CPC G01N 23/083; G01N 2223/301; G01N 23/04; G05D 1/0094

(57) ABSTRACT

An X-ray inspection device for a drone includes: a suspension device provided in the drone; an X-ray generator device for a drone, the X-ray generator device being movable up and down by the suspension device and including an X-ray source that emits an X-ray toward an object to be inspected; and a detector that is movable up and down by the suspension device and detects the X-ray transmitted through the object to be inspected.

### CROSS-REFERENCE OF RELATED APPLICATIONS

This application is a continuation of International Application No. PCT/JP2018/014028, filed Mar. 31, 2018, the entire contents of which are incorporated herein by reference.

### TECHNICAL FIELD

The present invention relates to an X-ray inspection device for a drone, an X-ray inspection device employing a drone, and an X-ray generator device for a drone, to perform X-ray inspection of objects to be inspected, installed at height, such as electric wires over transmission towers, ends of the electric wires, and pipework at height, by using a unmanned aerial vehicle (hereafter, “drone”).

### BACKGROUND ART

Conventionally, electric wire ends and pipework at height such as transmission towers are visually inspected by humans climbing up there. Such inspection, however, does not allow for quantitative inspection, with no record available, and only limited numbers of inspection a day is possible. Furthermore, the inspection work is dangerous.

Whereas the Applicant has filed applications for patents for the inventions of Patent Documents 1 and 2, for X-ray inspection of electric wires and pipework.

The invention of Patent Document 1 is a portable high-resolution X-ray inspection device that is small, thin and right-weight, and used for X-ray non-destructive inspection.

Patent Document 1, however, also requires human work at height, and is still dangerous.

The invention of Patent Document 2 is an X-ray non-destructive inspection device that is light and easy to install, and obtains non-destructive, multidirectional X-ray transmission images of linear objects to be inspected on the spot with no X-ray exposure, allowing for inspection of objects to be inspected with a high level of accuracy for the level of degradation, and real-time X-ray inspection of linear objects at height, such as electric wires, by autonomous travelling.

The installation thereof at height yet requires human work, and accordingly is dangerous.

On the other hand, a drone is an unmanned aerial vehicle that can hover in the air, and the flight thereof is controlled by wireless control by a human or autonomously. The drones are used in a variety of applications for industries and services, including aerial photography, product deliveries, etc. No application, however, is so far available for X-ray inspection at height by unmanned flight.

### BACKGROUND ART

### Patent Document

Patent Document 1: Japanese Unexamined Patent Application Publication No. 2017-191057 . . . Portable X-ray inspection device
Patent Document 2: Japanese Unexamined Patent Application Publication No. 2012-154627 . . . X-ray non-destructive inspection device

### SUMMARY

### Technical Problem

Therefore, an object of the present invention is to provide an X-ray inspection device/system for a drone, an X-ray inspection device employing a drone, an X-ray generator device for a drone allowing for X-ray inspection using a drone, on objects to be inspected, at height, such as electric wires over transmission towers, the electric wire ends, and pipework at height.

### Solution to Problem

The present invention to achieve the object is as follows:

(1)

An X-ray inspection device for a drone, the X-ray inspection device comprising:

a suspension device provided in the drone;

an X-ray generator device for a drone, the X-ray generator device being movable up and down by the suspension device and including an X-ray source that emits an X-ray toward an object to be inspected; and

a detector that is movable up and down by the suspension device and detects the X-ray transmitted through the object to be inspected.

(2)

The X-ray inspection device for a drone of (1), further comprising a fastener having the X-ray source and the detector face each other with the object to be inspected placed therebetween, and holding their positions.

(3)

The X-ray inspection device for a drone of (1), wherein the fastener is provided in the X-ray source; extends and retracts; and connects, attaches and detaches the X-ray source and the detector.

(4)

The X-ray inspection device for a drone of (1), wherein the suspension device includes:

a frame attached to the drone,

a first motor and a second motor provided on the frame,

a first suspender that is extended and retracted by the driving of the first motor and provided with the X-ray generator device for a drone on an end thereof, and

a second suspender that is extended and retracted by the driving of the second motor and provided with the detector on an end thereof.

(5)

The X-ray inspection device for a drone of (4), wherein the second motor is attached to the frame by a rail and a movable member slidable on the rail, and the focal distance between the X-ray source and the detector is changeable by sliding the detector.

(6)

The X-ray inspection device for a drone of (5), wherein the rail and the movable member slidable on the rail are a linear motor table.

(7)

The X-ray inspection device for a drone of any one of (4) to (6), wherein the frame is provided with a power source for driving the suspension device.

(8)

The X-ray inspection device for a drone of any one of (4) to (7), wherein the frame is provided with a control device for controlling the driving of the suspension device.

(9)

The X-ray inspection device for a drone of (3), wherein the fastener is driven by a power source of the X-ray source.

(10)

The X-ray inspection device for a drone of (1), wherein the X-ray source is provided with a second camera taking an image of the object to be inspected.

(11)

An X-ray inspection device employing a drone, the X-ray inspection device comprising: a drone; the X-ray inspection device for a drone of any one of (1) to (10); a remote controller controlling the behaviors of the drone; and a personal computer (PC) including a monitor that wirelessly obtains an X-ray image detected by the detector, and displays it in real time.

(12)

An X-ray inspection device employing a drone, the X-ray inspection device comprising: a drone; and the X-ray inspection device for a drone of any one of (1) to (10); wherein

the X-ray inspection device autonomously fly to a location to be inspected of the object to be inspected, according to a video-image of a first camera provided in the suspension device and a second camera provided in the X-ray source.

(13)

An X-ray generator device for a drone, the X-ray generator device comprising: an X-ray source emitting an X-ray toward an object to be inspected; a second camera taking an image of the object to be inspected; and a fastener connected to a detector.

### Advantageous Effects of Invention

With the configurations described above, the present invention allows for X-ray inspection using a drone, without human work, on objects to be inspected, at height, such as electric wires over transmission towers, the electric wire ends, and pipework at height.

### BRIEF DESCRIPTION OF DRAWINGS

FIG. 1 illustrates a pattern diagram of one side of an overall structure of an X-ray inspection device employing a drone as the present invention.

FIG. 2 illustrates a detailed view of an X-ray generator device for a drone as the present invention.

### DESCRIPTION OF EMBODIMENTS

Now, embodiments of the present invention will be explained in detail with reference to the accompanying drawings. The present invention, however, shall not be limited to those embodiments.

### Embodiment 1

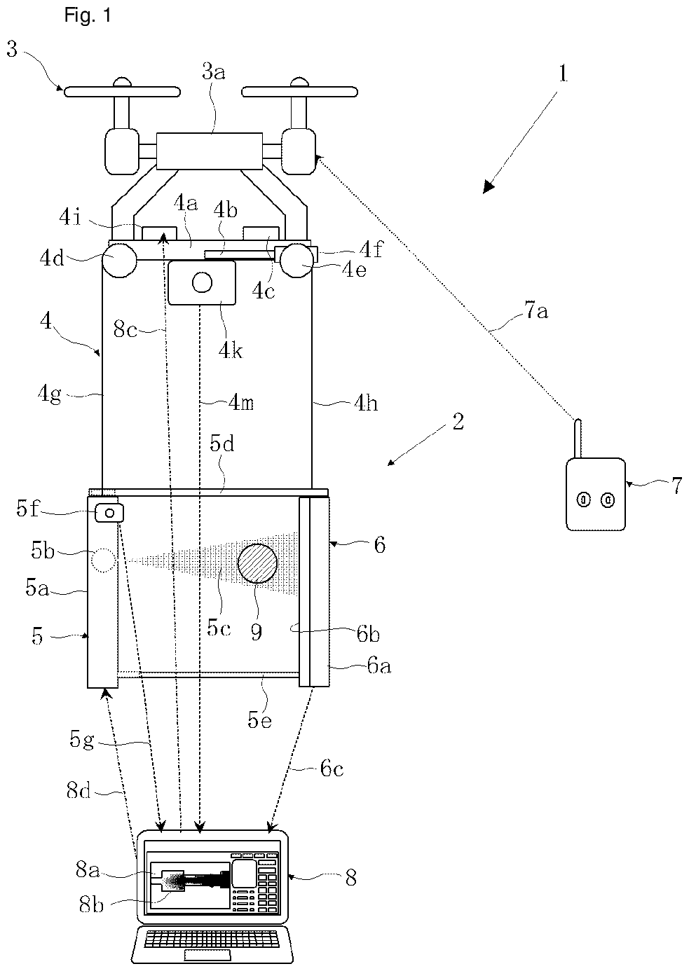

As illustrated in FIG. 1, an X-ray inspection device 1 using a drone comprises: an X-ray inspection device for a drone 2; a drone 3; a remote controller 7; and a personal computer (PC) 8.

The drone 3 includes: a main unit 3a including a propeller capable of unmanned flight and an engine; and a frame mounted on the main unit 3a. A camera (still camera and/or video device) may be provided (not illustrated). The remote controller 7 controls flight (movement, its speed, hovering, etc.) of the drone 3 by wireless communication 7a.

The drone 3 is not limited to a specific one as long as it can lift the weights of a suspension device 4, an X-ray generator device for a drone 5, a detector 6, etc. The remote controller 7 may be a commercially available one for drones.

Note that the remote controller 7 may control the flight of the drone 3 by connecting to the PC 8 to use a wireless function of the PC 8. Also, the remote controller 7 may be incorporated in the PC 8, or may be provided with a function of a PC.

The drone 3 is controlled by the remote controller 7 or the PC 8, however, its flight may also be autonomously controlled by the PC 8 based on camera image data 4m, 5g (video-image) obtained by a first camera 4k and a second camera described below, such that an X-ray source 5a and the detector 6 maintain prescribed positions relative to the object to be inspected 9, or that the main unit 3a of the drone 3 avoids obstacles.

The PC 8 includes a monitor 8a that digitally displays mainly the video-image of the camera described below and X-ray image data 6c obtained by the detector 6, and controls the driving of the suspension device 4, the driving of the X-ray generator device for a drone 5, and emission of the X-ray 5c.

The X-ray inspection device for a drone 2 includes: the suspension device 4 provided in the drone 3; the X-ray generator device for a drone 5 that is movable up and down by the suspension device 4 and emits the X-ray 5c toward the object to be inspected 9; and the detector 6 that is movable up and down by the suspension device 4 and detects the X-ray 5c transmitted through the object to be inspected 9.

The suspension device 4 includes: a frame 4a attached to the drone; a first motor 4d and a second motor 4e provided on the frame 4a; a first suspender 4g that extends and retracts according to the driving of the first motor 4d and is provided with the X-ray generator device for a drone 5 at its end; and a second suspender 4h that extends and retracts according to the driving of the second motor 4e and is provided with the detector 6 at its end. Providing the frame 4a allows for easier attachment and detachment between commercially available drones of different shapes and the X-ray inspection device for a drone, and as described below, the first camera 4k, a control device 4i, and a power source 4c can be mounted, increasing versatility as the driving system is easily, wirelessly controlled by a control signal 8c from the PC 8.

The second motor 4e is attached to the frame 4a by a rail 4b and a movable member 4f that is slidable on the rail, and the focal distance between the X-ray source 5a and the detector 6 is changeable by sliding the detector 6 in a horizontal direction. As a result, an X-ray image 8b with a high level of accuracy is obtained.

Generally, the detector 6 is lighter, and it is easier to slide the detector 6. The first motor 4d, of course, may be slidable in the same manner as the second motor 4e. Or, both the first motor 4d and the second motor 4e may be slidable.

Examples of the rail 4b and the movable member 4f (e.g., a plate) that is slidable along the rail 4b include a linear motor table in which the movable member 4f is moved to the right and left by transmitting the driving of a motor (not illustrated) to a belt.

Further, it is preferable to provide the frame 4a with the power source 4c to drive the suspension device 4. Also, the frame 4a is preferably provided with the control device 4i to control the driving of the suspension device 4. The frame 4a further includes the first camera 4k. By unitizing them in this manner, versatility of the present invention in use with commercially available drones is increased.

The photo-images or vide-images obtained by the first camera 4k are wirelessly sent to the PC 8 as the camera image data 4m, and can be checked on a monitor 8a in real time. The camera image data 4m may be sent by the control device 4i and the control signal 8c from the PC 8, described below.

The power source 4c is connected, by a lead wire (not illustrated), to the first motor 4d, the second motor 4e, a motor (not illustrated) for driving the movable member 4f, and the control device 4i, and supplies electrical power to them.

In response to the control signal 8c from the PC 8, the control device 4i controls the speed of the first motor 4d (the extension and retraction of the first suspender 4g and the vertical position of the X-ray generator device for a drone 5), the speed of the second motor 4e (the extension and retraction of the second suspender 4h and the vertical position of the detector 6), and the sliding range of the movable member 4f (the position of the detector 6 and the focal distance of the X-ray 5c), which are connected by lead wires (not illustrated). The control device 4i also facilitates the real-time display of video-images of the first camera 4k. Of course, the first camera 4k may send video-images to the PC 8 by its own wireless function independently of the control device 4i.

Examples of the first suspender 4g and the second suspender 4h include wires, belts, and measuring tape materials. These are rewound, released, extended, and retracted by rotation of the first motor 4d and the second motor 4e, to position each of the X-ray generator device for a drone 5 and the detector 6 to a desired position relative to the drone 3. The rotations of the first motor 4d and the second motor 4e are controlled independently of each other, and the lengths of the first suspender and the second suspender may differ.

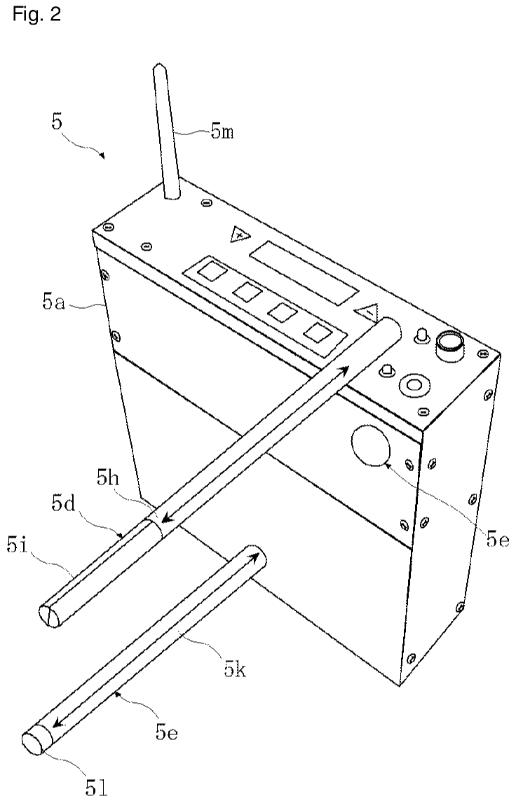

As FIGS. 1 and 2 illustrate, the X-ray generator device for a drone 5 includes: the X-ray source 5a including an X-ray tube 5b that is housed in a housing and emits the X-ray 5c toward the object to be inspected 9, a circuit (not illustrated) applying a voltage to the X-ray tube 5b, and a power source (not illustrated) driving them; and if required, a second camera 5f taking images of the object to be inspected 9; and a fastener (here, two different types of an upper fastener 5d and a lower fastener 5e) that is connected to the detector 6 and holds the positions (distances) of the X-ray source 5a and the detector 6 by preventing rotation of the X-ray source 5a and the detector 6 faced each other with the object to be inspected 9 placed therebetween.

For the X-ray source 5a, the X-ray source [2] of Patent Document 1, etc. may be used. For the X-ray tube 5b, the X-ray tube [5] (carbon nanostructure triode cold cathode X-ray tube) of Patent Document 1 may be used. Also, X-ray tubes other than a triode cold cathode X-ray tube may be used.

The driving of the X-ray source 5a is controlled by a control signal 8d from the PC 8 via an antenna 5m, and the camera image data 5g (video-image) of the second camera 5f is also wirelessly sent to the PC 8. Of course, the second camera 5f may send images to the PC 8 by its own wireless function independently of the X-ray source 5a.

The second camera 5f is provided near the object to be inspected 9, and its camera image data 5g (video-image) is used for positioning the X-ray source 5a and the detector 6 with a high level of accuracy, that is, manual positioning by manual operation of the remote controller 7 and the PC 8, or autonomous positioning by autonomous control thereof.

The structures, mechanism and positions of the upper fastener 5d and the lower fastener 5e are not especially limited, only if they allow for connection, attachment and detachment of the X-ray source 5a and the detector 6. Also, the first suspender 4g may be connected to the second suspender 4h. As FIG. 2 illustrates, if the upper fastener 5d and the lower fastener 5e are provided on the X-ray source 5a and driven by the power source of the X-ray source 5a, the attachment and detachment thereof are easily controlled.

As FIG. 2 illustrates, here, the upper fastener 5d includes, e.g., an extendable portion 5h one end of which is connected to a top surface of the X-ray source 5a, and a tip end portion 5i provided on the other end. The tip end portion 5i is forked, and pinches the second suspender 4h therebetween. The extension and retraction, pinching (opening and closing) of the upper fastener 5d are performed by the control signal 8d from the PC 8.

As FIG. 2 illustrates, the lower fastener 5e includes an extendable portion 5k one end of which is connected to a bottom of the X-ray source 5a, and a tip end portion 5l provided on the other end. The tip end portion 5l may be attached, by an electromagnet, to an area of the detector 6 formed of a steel material. The extension and retraction, and magnetic attachment and detachment of the lower fastener 5e are performed by the control signal 8d from the PC 8. That is, the magnetic attachment and detachment to and from the steel area of the detector 6 can be controlled by switching on/off the power source of the X-ray source 5a.

For the fastener, one or both of the upper fastener 5d and the lower fastener 5e may be provided, or two of either mechanism may be provided, and they may be provided on a side surface of the X-ray source 5a.

Providing the upper fastener 5d and the lower fastener 5e reduces shakes of the drone 3 and the effect of wind, and the X-ray source 5a and the detector 6 are maintained at desired positions (distances) to obtain clearer X-ray image 8b.

The detector 6 includes: a detection surface 6b detecting the X-ray 5c transmitted through the object to be inspected 9; and a main unit 6a, electrically connected to the detection surface 6b, for obtaining and recording X-ray image data 6c and wirelessly sending it to the PC 8, and for example, the X-ray detector [3] of Patent Document 1 may be used for the detector 6. For the detector 6, for example, a scintillator, CCD, CMOS, and CdTe semiconductor may be used.

### REFERENCE SIGNS LIST

1 X-ray inspection device employing a drone
2 X-ray inspection device for a drone
3 drone
3a main unit
4 suspension device
4a frame
4b rail
4c power source
4d first motor
4e second motor
4f movable member
4g first suspender
4h second suspender
4i control device
4k first camera
4m camera image data
5 X-ray generator device for a drone
5a X-ray source
5b X-ray tube
5c X-ray
5d upper fastener
5e lower fastener
5f second camera
5g camera image data
5h extendable portion
5i tip end portion
5k extendable portion
51 tip end portion
5m antenna
6 detector
6a main unit
6b detection surface
6c X-ray image data
7 remote controller
7a wireless communication
8 PC
8a monitor
8b X-ray image
8c control signal
8d control signal
9 object to be inspected

1. An X-ray inspection device for a drone, comprising:
a suspension device provided in the drone;
an X-ray generator for the drone, the X-ray generator device being movable up and down by the suspension device and comprising an X-ray source configured to emit an X-ray toward an object to be inspected; and
a detector configured to be movable up and down by the suspension device and to detect the X-ray transmitted through the object to be inspected.

2. The X-ray inspection device according to claim 1, further comprising a fastener holding the X-ray source and the detector such that X-ray source and the detector face each other with the object placed therebetween.

3. The X-ray inspection device according to claim 2, wherein the fastener is provided in the X-ray source and configured to extend and retract such that the fastener connects and disconnects the X-ray source and the detector.

4. The X-ray inspection device according to claim 1, wherein the suspension device comprises:
a frame attached to the drone,
a first motor and a second motor provided on the frame,
a first suspender configured to be extended and retracted by driving of the first motor and provided with the X-ray generator for the drone on an end of the first suspender, and
a second suspender configured to be extended and retracted by the driving of the second motor and provided with the detector on an end of the second suspender.

5. The X-ray inspection device according to claim 4, wherein the second motor is attached to the frame by a rail and a movable member slidable on the rail, and a focal distance between the X-ray source and the detector is changeable by sliding the detector.

6. The X-ray inspection device for a drone of claim 5, wherein the rail and the movable member slidable on the rail are a linear motor table.

7. The X-ray inspection device according to claim 4, wherein the frame is provided with a power source for driving the suspension device.

8. The X-ray inspection device according to claim 4, wherein the frame is provided with a control device for controlling the driving of the suspension device.

9. The X-ray inspection device according to claim 3, wherein the fastener is driven by a power source of the X-ray source.

10. The X-ray inspection device according to claim 1, wherein the X-ray source is provided with a camera configured to capture an image of the object to be inspected.

11. An X-ray inspection device employing a drone, comprising:
the drone;
the X-ray inspection device of claim 1;
a remote controller configured to control operations of the drone; and
a personal computer comprising a monitor configured to wirelessly obtain an X-ray image detected by the detector and display the X-ray image in real time.

12. An X-ray inspection device employing a drone, comprising:
the drone; and
the X-ray inspection device of claim 1, wherein
the X-ray inspection device is configured to perform an autonomous flight to a location of the object to be inspected, according to video-images captured by a first camera provided in the suspension device and a second-camera provided in the X-ray source.
